(19) United States
(12) Patent Application Publication
(10) Pub. No.: US 2008/0186462 A1
(43) Pub. Date: Aug. 7, 2008

(54) IMMERSION EXPOSURE APPARATUS AND METHOD OF MANUFACTURING DEVICE

(75) Inventor: Shinichi Shima, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/024,268

(22) Filed: Feb. 1, 2008

(30) Foreign Application Priority Data
Feb. 5, 2007 (JP) 2007-026070

(51) Int. Cl. G03B 27/52

(52) U.S. Cl. 355/30

(57) ABSTRACT

An immersion exposure apparatus has a projection optical system and a substrate stage. The substrate stage includes a chuck and a top plate located around the substrate held by the chuck. The top plate includes a measurement reference member. A liquid contacting area, on the surface of the top plate, which comes into contact with the liquid in exposing the substrate is coated with a coating film exhibiting liquid repellency against the liquid, and the area other than the liquid contacting area on the surface of the measurement reference member is not coated with the coating film.

### BACKGROUND OF THE INVENTION

1. Field of the Invention

The present invention relates to an immersion exposure apparatus which exposes a substrate via a liquid filling the space between a projection optical system and the substrate, and a method of manufacturing a device.

2. Description of the Related Art

A process of manufacturing a micropatterned semiconductor device such as an LSI or VLSI adopts a reduction projection exposure apparatus which reduces a pattern formed on a reticle and projects and transfers it onto a substrate coated with a photosensitive agent. As the degrees of integration of semiconductor devices improve, demands have arisen for further micropatterning. The exposure apparatus has coped with the micropatterning along with the development of the resist process.

As means for improving the resolving power of an exposure apparatus, it is a common practice to shorten the exposure wavelength and to increase the numerical aperture (NA) of a projection optical system.

The exposure wavelength is shifting from the 365-nm i-line to a KrF excimer laser oscillation wavelength of about 248 nm. Furthermore, an ArF excimer laser having an oscillation wavelength of about 193 nm is under development. A fluorine (F2) excimer laser having an oscillation wavelength of about 157 nm is also under development.

A projection exposure method using immersion exposure is receiving a great deal of attention as another technique of improving the resolving power. Unlike a typical prior art, the immersion exposure apparatus performs projection exposure by filling the space between the final surface of a projection optical system and the surface of an exposure target substrate (e.g., a wafer) with a liquid instead of a gas.

The immersion exposure method has a merit of improving the resolving power as compared with the prior art even when a light source having the same wavelength as in the prior art is used. Assume, for example, that the liquid supplied to the space between the projection optical system and the substrate is pure water (refractive index: 1.33), and the maximum incident angle of a light beam imaged on the substrate is the same between the immersion exposure method and the prior art. In this case, the immersion exposure method improves the resolving power to 1.33 times that in the prior art. This amounts to increasing the NA of the projection optical system in the prior art to 1.33 times. The immersion exposure method can obtain a resolving power defined by NA=1 or more, that is practically impossible in the prior art.

To support the liquid in the immersion area, a liquid supporting plate (to be referred to as a “top plate” hereinafter) having a surface nearly flush with the substrate surface is arranged on a substrate stage of an immersion exposure apparatus.

The top plate includes a slit plate. A light-receiving unit which receives light having passed through the projection optical system via the slit plate is arranged on the substrate stage.

Japanese Patent Laid-Open No. 2005-191557 discloses a proposal to perform a liquid repellent treatment on the surface of the top plate, in order to prevent the liquid from remaining on the top plate. This patent reference additionally discloses a proposal to use a coating film made of, e.g., tetrafluoroethylene as the liquid repellent treatment method.

Japanese Patent Laid-Open Nos. 10-167767, 11-181355, 2001-329174, and 2001-335693 disclose techniques of performing a liquid repellent treatment on a glass surface.

Japanese Patent Laid-Open No. 10-167767 discloses a method of coating the glass surface with a reactive aqueous emulsion containing alkoxysilane and drying it to form a liquid-repellent film.

Japanese Patent Laid-Open No. 11-181355 discloses a method of coating the glass surface with an aqueous emulsion containing hydrolyzed fluorocarbon silane and drying it to form a liquid-repellent film.

Japanese Patent Laid-Open No. 2001-329174 discloses an aqueous emulsion containing hydrolyzed fluorocarbon silane, which is suitable to form a heat-resistant, liquid-repellent coating film with excellent durability.

Japanese Patent Laid-Open No. 2001-335693 discloses an aqueous emulsion containing hydrolyzed fluorocarbon silane, which is suitable to form an oil-resistant, antifouling, heat-resistant, liquid-repellent coating film.

FIG. 2 is a plan view showing a substrate stage. A measurement reference member FM (e.g., the above-described slit plate) is arranged around a substrate W. Since an immersion exposure apparatus has a liquid immersion area IML larger than a projection area, a liquid contacting area IMW comes into contact with a liquid, as shown in FIG. 3, in exposing the substrate. The liquid contacting area IMW is an area on the substrate stage, which comes into contact with the liquid after the substrate stage moves relative to the liquid immersion area IML in exposure. The liquid contacting area IMW includes the measurement reference member FM.

The measurement reference member FM is used for apparatus calibration or alignment between an original and a substrate as a component of, e.g., a TTL detection system, an off-axis detection system, a substrate surface height and tilt detection system, an illuminance detection system, or an aberration detection system of a projection optical system. The measurement reference member is made of, e.g., glass on which a mark or opening serving as a reference is formed.

In general, glass is hydrophilic. When the measurement reference member comes into contact with the liquid immersion area IML in exposing the substrate, and then moves outside it, the liquid remains on the measurement reference member. When the exposure operation continues in this state, the liquid on the measurement reference member is likely to scatter.

Even though the remaining liquid amount can be decreased to some extent by decreasing the velocity at which the liquid immersion area moves on the measurement reference member, it is difficult to completely remove it. Furthermore, when the exposure velocity (the movement velocity of the substrate stage) is decreased in an exposure target area on the substrate, in which the liquid immersion area passes on the measurement reference member, i.e., an exposure target area in the peripheral portion of the substrate, the throughput lowers.

To prevent the liquid from remaining on the measurement reference member, there is known a method of performing a liquid repellent treatment on the surface of the measurement reference member. There is also known a method of performing a liquid repellent treatment using polytetrafluoroethylene. However, when an excimer laser, especially, an ArF excimer laser irradiates the polytetrafluoroethylene that is in contact with the liquid, the liquid repellency decreases and contaminants are produced, resulting in defects upon exposing the substrate. Furthermore, when a polytetrafluoroethylene film is formed on the surface of the measurement reference member, and the substrate surface height and tilt detection system detects the surface of the measurement reference member using light projection and reception, a detection error is generated because of an unstable surface shape. Since the polytetrafluoroethylene film has low transmittances with respect to exposure light and detection light from, e.g., the off-axis detection system, the detection accuracy decreases. It is also necessary to improve the durability, adhesion, and liquid repellency of the coating film from the viewpoint of practical application.

### SUMMARY OF THE INVENTION

It is an exemplary object of the present invention to reduce the amount of liquid remaining in an area, which comes into contact with the liquid in exposing a substrate, on the surface of a substrate stage top plate including a measurement reference member, without deteriorating the accuracy of measurement using the measurement reference member.

According to the first aspect of the present invention, there is provided an immersion exposure apparatus comprising: a projection optical system which projects exposure light from an original onto a substrate; and a substrate stage which holds the substrate and moves the substrate, wherein the substrate stage includes a chuck which holds the substrate, and a top plate located around the substrate held by the chuck, wherein the top plate includes a measurement reference member, wherein a surface of the top plate is coated with a coating film exhibiting liquid repellency against the liquid, and wherein an area, on a surface of the measurement reference member, irradiated with measurement light having the same wavelength as a wavelength of the exposure light is not coated with the coating film.

According to the second aspect of the present invention, there is provided an immersion exposure apparatus comprising: a projection optical system which projects exposure light from an original onto a substrate via an original; and a substrate stage which holds the substrate and moves, wherein the substrate stage includes a chuck which holds the substrate, and a top plate located around the substrate held by the chuck, wherein the top plate includes a measurement reference member, wherein an area, on a surface of the measurement reference member of the top plate, other than a measurement area exposed with the exposure light to perform measurement using the exposure light is coated with a coating film exhibiting liquid repellency against the liquid.

According to the third aspect of the present invention, there is provided an immersion exposure apparatus comprising: a projection optical system which projects exposure light from an original onto a substrate; and a substrate stage which holds the substrate and moves the substrate, wherein the substrate stage includes a chuck which holds the substrate, and a top plate located around the substrate held by the chuck, wherein the top plate includes a measurement reference member, wherein a liquid contacting area, on a surface of the top plate, which comes into contact with the liquid in exposing the substrate is coated with a coating film exhibiting liquid repellency against the liquid, and wherein an overall surface of the measurement reference member is located outside the liquid contacting area, which comes into contact with the liquid, and is not coated with the coating film.

According to the present invention, it is possible to, e.g., reduce the amount of liquid remaining in an area, which comes into contact with the liquid in exposing a substrate, on the surface of a substrate stage top plate including a measurement reference member, without deteriorating the accuracy of measurement using the measurement reference member.

Further features and aspects of the present invention will become apparent from the following description of exemplary embodiments with reference to the attached drawings.

### BRIEF DESCRIPTION OF THE DRAWINGS

FIG. 1 is a view for explaining an immersion exposure apparatus;

FIG. 2 is a plan view showing a substrate stage;

FIG. 3 is a view for explaining a liquid immersion area and liquid contacting area;

FIG. 4 is a plan view showing a reference mark surface;

FIGS. 5A and 5B are sectional views showing reflectance measurement samples;

FIG. 6 is a table showing the reflectance measurement result;

FIG. 7 is a view for explaining the second embodiment of the present invention;

FIG. 8 is a flowchart for explaining the device manufacture using an exposure apparatus; and

FIG. 9 is a flowchart illustrating details of the wafer process in step S4 of the flowchart shown in FIG. 8.

### DESCRIPTION OF THE EMBODIMENTS

### First Embodiment

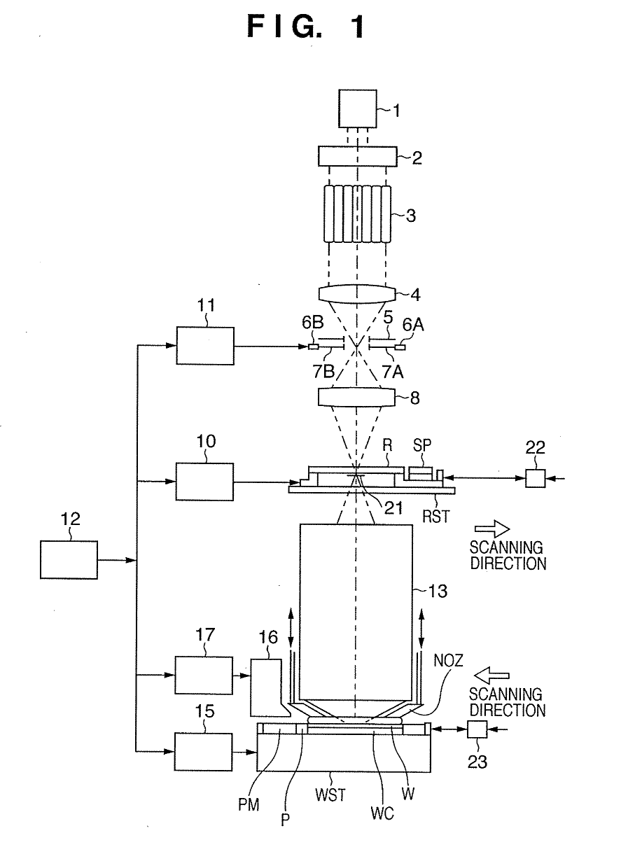

FIG. 1 shows the outline of an exposure apparatus which has a projection optical system which projects exposure light onto a substrate via an original, and exposes the substrate via a liquid filling the space between the projection optical system and the substrate according to the first and second embodiments of the present invention. An illumination optical system including a light source 1 and an illumination light shaping optical system 2 to a relay lens system 8 illuminates a reticle (mask) R serving as the original in a rectangular, slit-like illumination area 21 with a uniform illuminance. A circuit pattern image of the reticle R in the slit-like illumination area 21 is transferred onto the substrate W via a projection optical system 13. The light source 1 can be an excimer laser beam source using, e.g., an F2 excimer laser or ArF excimer laser, a metal vapor laser beam source, a pulse light source using, e.g., a harmonic generator of a YAG laser, or a continuous light source using, e.g., a combination of a mercury lamp and elliptic reflecting mirror. When a pulse light source is used, exposure is switched on or off under the control of power supplied from its power supply. When a continuous light source is used, exposure is switched on or off by a shutter in the illumination light shaping optical system 2. In this embodiment, as a movable blind (variable field stop) 7 is provided as will be described later, exposure may be switched on or off by opening or closing the movable blind 7.

Referring to FIG. 1, illumination light from the light source 1 is set to have a predetermined diameter by the illumination light shaping optical system 2 and reaches a fly-eye lens 3. A number of secondary sources are formed on the exit surface of the fly-eye lens 3. The illumination light from these secondary sources is converged by a condenser lens 4 and reaches the movable blind (variable field stop) 7 via a stationary field stop 5. Although the field stop 5 is inserted on the side of the condenser lens 4 with respect to the movable blind 7 in FIG. 1, it may be inserted on the opposite side, i.e., on the side of the relay lens system 8.

A rectangular, slit-like opening is formed in the field stop 5. A light beam having passed through the field stop 5 turns into the one having a rectangular, slit-like section, and enters the relay lens system 8. The longitudinal direction of the slit is perpendicular to the drawing surface. The relay lens system 8 makes the movable blind 7 conjugate to the pattern forming surface of the reticle R. The movable blind 7 includes two blades (light-shielding plates) 7A and 7B which define its dimension in the scanning direction (X direction), and two blades (not shown) which define its dimension in a non-scanning direction perpendicular to the scanning direction (to be described later). The blades 7A and 7B which define the blind dimension in the scanning direction are respectively supported by driving units 6A and 6B to be independently movable in the scanning direction. Similarly, the two blades (not shown) which define the blind dimension in the non-scanning direction are respectively supported to be independently drivable in the non-scanning direction.

In this embodiment, the illumination light strikes only a desired exposure target area, which is set by the movable blind 7, in the slit-like illumination area 21 on the reticle R set by the stationary field stop 5. The relay lens system 8 is a bilateral telecentric optical system and maintains telecentricity in the slit-like illumination area 21 on the reticle R.

The reticle R is held by a reticle stage RST. An interferometer 22 detects the position of the reticle stage RST, and a reticle stage driving unit 10 drives the reticle stage RST. A reference plate SP on which a reference mark is formed is arranged on the reticle stage RST. An apparatus calibration reference mark is formed on the reference plate SP.

The circuit pattern image on the reticle R, which falls within the slit-like illumination area 21 and is defined by the movable blind 7, is projected and transferred onto a substrate W by exposure via the projection optical system 13. In a two-dimensional plane perpendicular to the optical axis of the projection optical system 13, the scanning direction of the reticle R relative to the slit-like illumination area 21 is defined as the +X direction (or −X direction), and a direction parallel to the optical axis of the projection optical system 13 is defined as the Z direction.

The reticle stage RST scans the reticle R in the scanning direction (+X direction or −X direction) upon being driven by the reticle stage driving unit 10. A movable blind controller 11 controls the operation of the driving units 6A and 6B and non-scanning direction driving units of the movable blind 7. A main control system 12 which controls the operation of the entire apparatus controls the operations of the reticle stage driving unit 10 and movable blind controller 11.

The substrate W is transported by a substrate transport device (not shown) and is chucked by vacuum suction by a substrate chuck WC arranged on a substrate stage WST which holds and moves the substrate W. The substrate stage WST includes, e.g., an X-Y stage for aligning the substrate W in a plane perpendicular to the optical axis of the projection optical system 13 and scanning the substrate W in the ±X directions, and a Z stage for aligning the substrate W in the Z direction.

An interferometer 23 detects the position of the substrate stage WST. Although only one direction is illustrated in FIG. 1, the interferometer 23 detects the position of the substrate stage WST in the X and Y directions and the rotation directions about the X- and Y-axes. A measurement reference member FM serving as a reference of alignment between the reticle R and the substrate W is arranged on the substrate stage WST. The measurement reference member FM includes a reference mark and a measurement unit for measuring the position of the reference mark. Alternatively, the measurement reference member FM may include a light transmissive area instead of the reference mark, and a measurement unit for detecting light transmitted through the light transmissive area, to allow measurement associated with at least one of alignment, focus, image performance, illuminance, and the like. The measurement reference member FM may further include a light reflective area. Note that a member which has at least one of the reference mark, light transmissive area, light reflective area, and the like and is provided for measurement will be generically referred to as a measurement reference member or a reference member simply.

A top plate P which includes the measurement reference member FM and is located around the substrate W held by the substrate chuck WC such that the top plate P is nearly flush with the surface of the substrate W is chucked on the substrate stage WST by vacuum suction. A liquid supply/recovery unit NOZ is arranged above the substrate W on the image plane side of the projection optical system 13.

The liquid supply/recovery unit NOZ connects to a supply unit including a liquid supply pipe, pump, thermoregulator, and filter, and a recovery unit including a liquid recovery pipe, pump, and gas-liquid separator (all of which are not shown). The main control system 12 controls the supply and recovery of the supply unit and recovery unit.

An off-axis alignment sensor 16 is arranged above the substrate W. The alignment sensor 16 detects an alignment mark on the substrate. A controller 17 processes the detected alignment mark and sends the processing result to the main control system 12.

The main control system 12 controls the alignment operation and scanning operation of the substrate stage WST via a substrate stage driving unit 15. To transfer the pattern image on the reticle R onto each shot region on the substrate W via the projection optical system 13 by scanning exposure, the reticle stage RST scans the reticle R at a velocity VR in the −X direction (or +X direction) relative to the slit-like illumination area 21 set by the field stop 5 shown in FIG. 1. Letting β be the projection magnification of the projection optical system 13, the substrate W is scanned at a velocity VW (=β·VR) in the +X direction (or −X direction) in synchronism with the scanning of the reticle R. With this operation, the circuit pattern image on the reticle R is sequentially transferred onto each shot region on the substrate W.

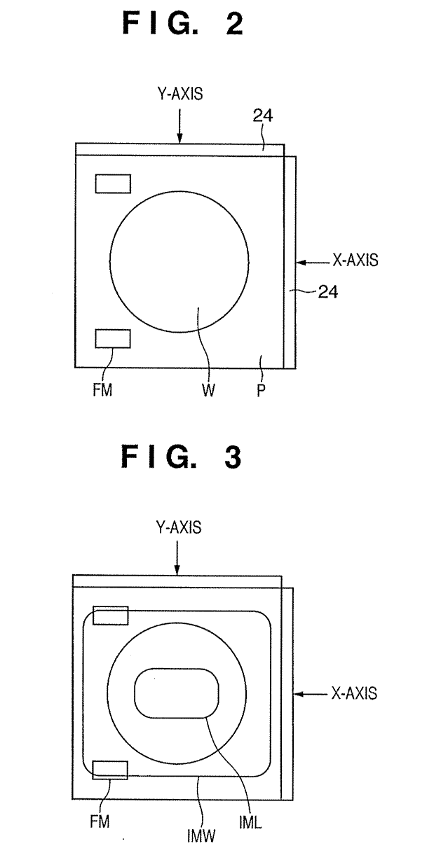

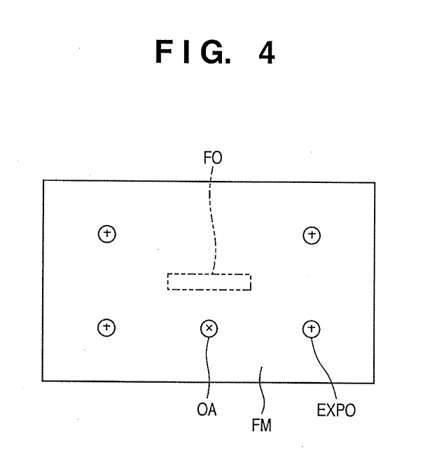

FIG. 2 is a plan view showing the substrate stage WST. The measurement reference member FM is arranged around the substrate W. FIG. 3 conceptually shows a portion which comes into contact with a liquid immersion area IML in exposing the substrate as a liquid contacting area IMW. Since the measurement reference member FM is included in the liquid immersion area IML, it comes into contact with a liquid in exposing the substrate. FIG. 4 is a plan view showing the surface of the measurement reference member. Reference symbol EXPO indicates a measurement area exposed with exposure light to perform measurement using it; OA, a measurement area detected by an off-axis detection system; and FO, an area detected by a substrate height and tilt detection system. Since the circular area EXPO is exposed with the exposure light, it is not coated with a liquid-repellent (water-repellent) coating film for increasing the contact angle. The actual area EXPO has a diameter of about 1 to 2 mm, so it has an area of several percentages of the overall area of the reference member. Even if the liquid remains in this area, its amount is so small that its scattering and vaporization heat have little influence on the apparatus operation. A light transmissive area of the exposure light or a measurement mark for measurement using the exposure light as the measurement light is formed in the area EXPO.

An area other than the area EXPO, including the areas OA and FO, is not exposed with exposure light to perform measurement using it, and is coated with a coating film exhibiting liquid repellency against a given liquid to increase the contact angle. In this embodiment, this area is coated with amorphous carbon, e.g., diamond-like carbon. In general, diamond-like carbon has a good light transmittance in the near-infrared range and has a light transmittance of about 50% even in the wavelength range of about 500 nm to 600 nm used in the off-axis detection system. This allows detection even when a mark for the off-axis detection system is coated with diamond-like carbon. Hence, neither a measurement failure nor a decrease in measurement accuracy occurs due to a low transmittance with respect to the detection light wavelength of the off-axis detection system, unlike the prior art which forms the reference member using polytetrafluoroethylene.

The diamond-like carbon film is made of an amorphous substance which contains C (carbon) and H (hydrogen) and partially includes a diamond structure. Since this film has no crystal grain boundary, its surface is very smooth. This film can be used to coat the surface of the reference member because it can even serve as the reflection surface of the height and tilt detection system. Hence, a measurement error generated by the substrate height and tilt detection system because of an unstable surface shape in the prior art can be reduced by using an amorphous carbon film such as a diamond-like carbon film.

When a TTL detection system detects the measurement reference member FM, the main control system 12 confirms the position of the substrate stage WST to determine whether a certain area on it is coated with a liquid-repellent coating film, i.e., has a large contact angle. On the basis of the determination result, the main control system 12 controls an illumination unit which illuminates the surface of the reference member with exposure light so as not to illuminate an area on the surface of the reference member, which is coated with the coating film. The main control system 12 confirms the position of the substrate stage WST even when the peripheral portion of the substrate is exposed. If a certain area in this portion is coated with the coating film and has a large contact angle, an error message is displayed without illuminating it. The main control system 12 also functions as a controller which controls the illumination unit which illuminates the surface of the measurement reference member with exposure light.

The coating film can be the one formed by coating the reference member with an aqueous emulsion containing hydrolyzed fluorocarbon silane, in addition to an amorphous carbon film. More specifically, Zonyl TC Coat manufactured by Du Pont can be used. In this case, it is possible to form a coating film as thin as 20 nm to 30 nm. Since this film can ensure a flatness equal to that of the reference member, it is greatly advantageous to measurement by the measurement system.

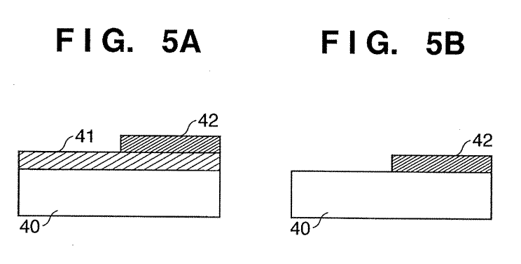

The off-axis detection system uses a wavelength of about 400 nm (inclusive) to 800 nm (inclusive). The wafer height and tilt detection system also uses measurement light of this wavelength range. The off-axis detection system and height and tilt detection system sometimes illuminate the measurement reference member while it is not in contact with the liquid, thereby measuring the light via the measurement reference member. For example, this applies to an exposure apparatus which reciprocates the wafer stage between an exposure station for immersion exposure and a measurement station for measuring the surface shape of a substrate and the layout of shot regions formed on it. If the measurement is performed while the measurement reference member is not in contact with the liquid, it is especially important to select a substance having transparency with respect to the measurement light to form the coating film of the measurement reference member. To coat the surface of the measurement reference member FM with Zonyl TC Coat so as to use it for measurement, it must have a desired reflectance with respect to the measurement light wavelength. FIGS. 5A and 5B show reflectance measurement samples. In the sample shown in FIG. 5A, a silica glass substrate 40 on which chromium 41 is deposited is partially coated (coating portion 42). In the sample shown in FIG. 5B, a silica glass substrate 40 is partially coated (coating portion 42).

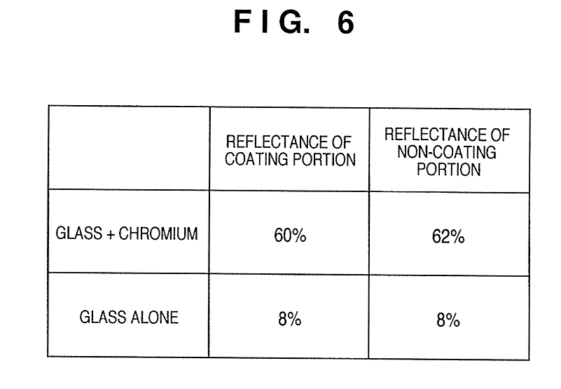

FIG. 6 shows the reflectance measurement result of both the samples as the average value of the reflectances in each wavelength. This result reveals that the reflectances of both the coating portion and non-coating portion of the glass surface are 8%, while those of the chromium portion are about 60%. In general, a mark formed on the measurement reference member FM is made of chromium. As is obvious from this reflectance measurement result, when the off-axis detection system detects the mark on the measurement reference member FM, it is possible to ensure a reflectance difference of about 50%. The reflectance difference of about 50% is large enough to detect the position of the mark from its image with high accuracy.

The wafer height and tilt detection system irradiates the surface of the reference member with measurement light via, e.g., an oblique-incidence optical system to detect the light reflected by it. The wafer height and tilt detection system can measure the reference member with high accuracy as long as the above-reflectance is ensured.

From the viewpoint of the measurement accuracy, it is also possible to use an amorphous carbon film and a film formed by coating the reference member with an aqueous emulsion containing alkoxysilane and drying it.

The above-described coating films can be used when the off-axis detection system, wafer height and tilt detection system, and the like perform measurement using the measurement reference member. These two detection systems each constitute a measurement unit which illuminates the measurement reference member with measurement light having a wavelength different from that of exposure light while it is not in contact with the liquid, thereby measuring the light via the measurement reference member.

When the off-axis detection system, wafer height and tilt detection system, and the like perform measurement, detection light having a longer wavelength is desirably used from the viewpoint of the durability of the coating film. The detection light desirably has a wavelength of 500 nm or 600 nm or more.

Although the coating of the surface of the reference member has been described above, the present invention is not particularly limited to this. The above-described coating films can be used to coat the surfaces of members which are likely to come into contact with a liquid or to be immersed, such as the top plate, wafer stage, and interferometer mirror other than the reference member. The above-described coating films are useful because they are more excellent in the adhesion, durability, and liquid repellency than fluorine-based resin films and therefore can reduce the replacement frequency of a coated member.

According to this embodiment, the liquid never remains on the reference member on the substrate stage even as the liquid immersion area comes into contact with the reference member when the immersion exposure apparatus exposes the substrate. This makes it possible to prevent troubles such as the generation of rust due to the scattering of the liquid. The throughput never lowers because it is unnecessary to decrease the exposure velocity in exposing the peripheral portion of the substrate. Since a transmittance and stable reflection surface can be ensured on the mark for the off-axis detection system and in the detection area of the height and tilt detection system, high-accuracy detection is possible. It is also possible to prevent a decrease in contact angle and the generation of contaminants because an area having a large contact angle with respect to the liquid is not irradiated with light including the same wavelength as that of exposure light.

### Second Embodiment

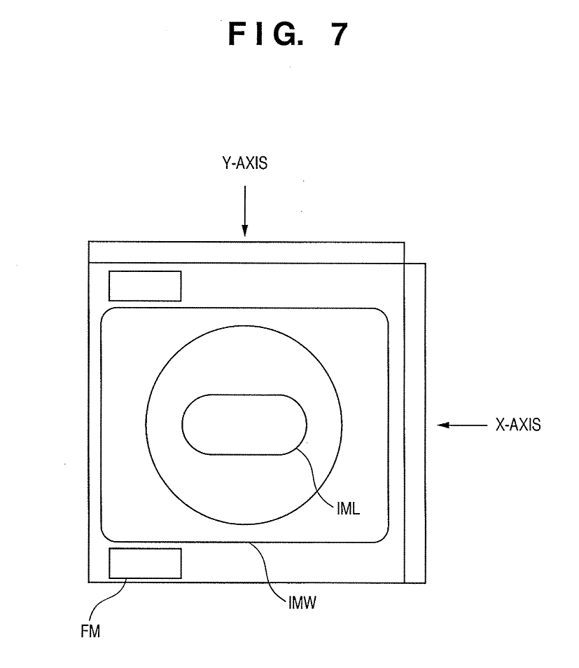

The second embodiment will be explained with reference to FIG. 7. FIG. 7 is different from FIG. 3 in that the overall surface of a measurement reference member is located outside a liquid contacting area IMW.

The surface of the reference member is located at a position at which it does not come into contact with the liquid in exposing a substrate. Since a liquid immersion area never comes into contact with the surface of the reference member, the liquid never remains on it. Since the surface of a reference mark portion is made of a hydrophilic material such as glass, it is possible to ensure a transmittance and reflectance with respect to exposure light and detection light of an off-axis detection system, thus attaining high-accuracy detection. In addition, since a height and tilt detection system can ensure a stable reflection surface with a good flatness, high-accuracy detection is possible.

The reference member described in each of the first and second embodiments can be the same as that disclosed in Japanese Patent Laid-Open No. 2005-175034. To measure the illuminance using the reference member, an illuminance sensor, for example, can be the same as that disclosed in Japanese Patent Laid-Open No. 11-16816. To measure the imaging performance using the reference member, a wavefront aberration measurement unit, for example, can be the same as that disclosed in Japanese Patent Laid-Open No. 8-22951. Since, however, the wavefront aberration measurement unit disclosed in Japanese Patent Laid-Open No. 8-22951 has an opening as the measurement slit, it is necessary to form a slit-like transmissive area using, e.g., a glass plate and light-shielding film for immersion. Although the first and second embodiments have exemplified a scanning exposure apparatus, the present invention is not particularly limited to this and may be applied to a step & repeat type exposure apparatus.

Although one substrate stage is used in the above description, a plurality of substrate stages may be used. In this case, the same effect can be produced as long as a measurement reference member arranged on each substrate stage has the arrangement described in the first or second embodiment.

### Embodiment of Device Manufacture

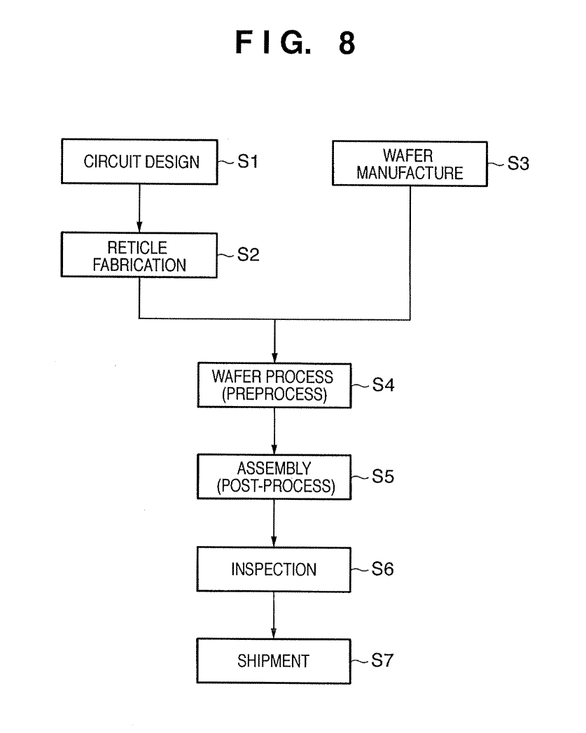

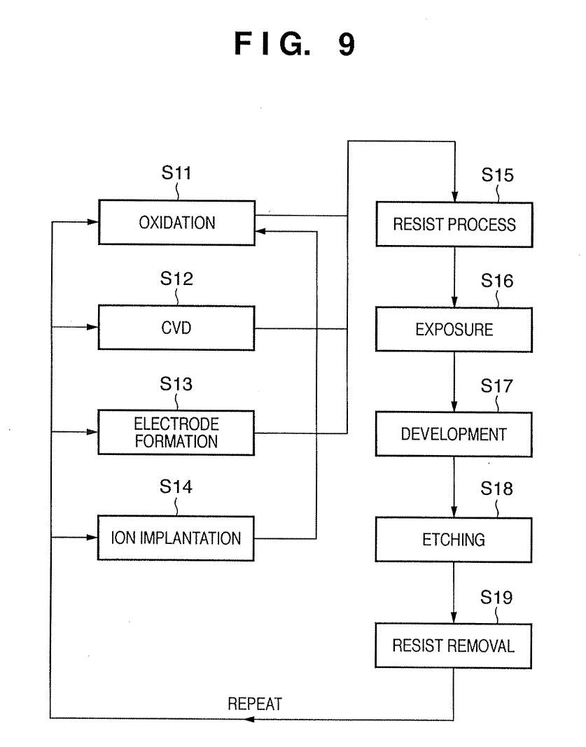

An embodiment of a method of manufacturing a device using the above-described immersion exposure apparatus will be explained next with reference to FIGS. 8 and 9.

FIG. 8 is a flowchart for explaining the manufacture of a device (e.g., a semiconductor device or liquid crystal device). A method of manufacturing a semiconductor device will be exemplified here.

In step S1 (circuit design), the circuit of a semiconductor device is designed. In step S2 (reticle fabrication), a reticle is fabricated on the basis of the designed circuit pattern. In step S3 (wafer manufacture), a wafer (also called a substrate) is manufactured using a material such as silicon. In step S4 (wafer process) called a preprocess, the above-described immersion exposure apparatus forms an actual circuit on the wafer by lithography using the reticle and wafer. In step S5 (assembly) called a post-process, a semiconductor chip is formed using the wafer manufactured in step S4. This step includes an assembly step (dicing and bonding) and packaging step (chip encapsulation). In step S6 (inspection), the semiconductor device manufactured in step S5 undergoes inspections such as an operation confirmation test and durability test. After these steps, the semiconductor device is completed and shipped in step S7.

FIG. 9 is a flowchart illustrating details of the wafer process in step S4. In step S11 (oxidation), the wafer surface is oxidized. In step S12 (CVD), an insulating film is formed on the wafer surface. In step S13 (electrode formation), an electrode is formed on the wafer by deposition. In step S14 (ion implantation), ions are implanted into the wafer. In step S15 (resist process), a photosensitive agent is applied on the wafer. In step S16 (exposure), the above-described exposure apparatus is used to expose the wafer via the circuit pattern formed on the reticle. In step S17 (development), the exposed wafer is developed. In step 18 (etching), portions other than the developed resist image are etched. In step 19 (resist removal), any unnecessary resist remaining after etching is removed. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-026070, filed Feb. 5, 2007, which is hereby incorporated by reference herein in its entirety.

What is claimed is:

1. An immersion exposure apparatus comprising:
a projection optical system which projects exposure light from an original onto a substrate; and
a substrate stage which holds the substrate and moves the substrate,
wherein said substrate stage includes a chuck which holds the substrate, and a top plate located around the substrate held by said chuck,
wherein said top plate includes a measurement reference member,
wherein a surface of said top plate is coated with a coating film exhibiting liquid repellency against the liquid, and
wherein an area, on a surface of said measurement reference member, irradiated with measurement light having the same wavelength as a wavelength of the exposure light is not coated with said coating film.

2. The apparatus according to claim 1, further comprising an illumination unit which illuminates the surface of said measurement reference member with the exposure light, and a controller which controls said illumination unit so as not to illuminate the area, on the surface of said measurement reference member, coated with said coating film.

3. The apparatus according to claim 1, wherein said measurement reference member includes a reference mark.

4. The apparatus according to claim 1, wherein said measurement reference member includes a light transmissive area.

5. The apparatus according to claim 3, further comprising a measurement unit which measures a position of said reference mark.

6. The apparatus according to claim 4, further comprising a measurement unit which measures the light transmitted through said light transmissive area.

7. The apparatus according to claim 1, further comprising a measurement unit which illuminates said measurement reference member with measurement light having a wavelength different from a wavelength of the exposure light while said measurement reference member is not in contact with the liquid, thereby measuring the light via said measurement reference member,
wherein said coating film has transparency with respect to the measurement light.

8. The apparatus according to claim 7, wherein said measurement unit measures one of a position of a mark formed on said measurement reference member, and a height of said measurement reference member.

9. The apparatus according to claim 7, wherein the wavelength of the measurement light is not less than 400 nm to not greater than 800 nm.

10. The apparatus according to claim 1, wherein said coating film includes one of a film formed by coating the liquid contacting area with an aqueous emulsion containing hydrolyzed fluorocarbon silane and drying the aqueous emulsion, a film formed by coating the liquid contacting area with a reactive aqueous emulsion containing alkoxysilane and drying the reactive aqueous emulsion, and an amorphous carbon film.

11. A method of manufacturing a device, said method comprising:
exposing a substrate using an immersion exposure apparatus defined in claim 1;
developing the exposed substrate; and
processing the developed substrate to manufacture the device.

12. An immersion exposure apparatus comprising:
a projection optical system which projects exposure light from an original onto a substrate; and
a substrate stage which holds the substrate and moves the substrate,
wherein said substrate stage includes a chuck which holds the substrate, and a top plate located around the substrate held by said chuck,
wherein said top plate includes a measurement reference member, and
wherein an area, on a surface of said measurement reference member of said top plate, other than a measurement area exposed with the exposure light to perform measurement using the exposure light is coated with a coating film exhibiting liquid repellency against the liquid.

13. An immersion exposure apparatus comprising:
a projection optical system which projects exposure light from an original onto a substrate; and
a substrate stage which holds the substrate and moves the substrate,
wherein said substrate stage includes a chuck which holds the substrate, and a top plate located around the substrate held by said chuck,
wherein said top plate includes a measurement reference member,
wherein a liquid contacting area, on a surface of said top plate, which comes into contact with the liquid in exposing the substrate is coated with a coating film exhibiting liquid repellency against the liquid, and
wherein an overall surface of said measurement reference member is located outside the liquid contacting area, which comes into contact with the liquid, and is not coated with said coating film.
